(19) United States
(12) Patent Application Publication
(10) Pub. No.: US 2020/0158301 A1
(43) Pub. Date: May 21, 2020

(54) Lighting System

(71) Applicants: Jeff Scott, Crested Butte, CO (US); Jay Whitacre, Crested Butte, CO (US)

(72) Inventors: Jeff Scott, Crested Butte, CO (US); Jay Whitacre, Crested Butte, CO (US)

(21) Appl. No.: 15/838,227

(22) Filed: Dec. 11, 2017

Related U.S. Application Data
(60) Provisional application No. 62/434,798, filed on Dec. 15, 2016.

(51) Int. Cl. F21S 6/00; F21V 1/06; F21V 21/088; F21V 33/00; F21S 9/02; F21V 23/04; F21S 4/10

(52) U.S. Cl. CPC F21S 6/005; F21V 1/06; F21V 21/088; F21Y 2115/10; F21S 9/02; F21V 23/0435; F21S 4/10; F21V 33/008

(57) ABSTRACT

The present disclosure provides a lighting system for use while camping. The lighting system has several embodiments that generally include a cordless LED lamp powered by a rechargeable battery, a light shade surrounding the LED lamp, an aerial mast that supports the LED lamp and light shade above the camping space, and wireless means for remotely controlling the system. The components of the system cooperate to provide transportable and customizable lighting solutions for a user.

### CROSS-REFERENCE TO RELATED APPLICATION

This application claims the benefit of U.S. Provisional Application No. 62/434,798, filed Dec. 15, 2016.

### FIELD OF THE INVENTION

The present invention relates generally to modular camping lighting systems.

### BACKGROUND ART

Camping light sources have generally consisted of candles, fossil fuel lanterns, and lanterns or flashlights powered by disposable batteries. These light sources are typically handheld or placed upon a table or rock. Frequently, these traditional light sources do not provide adequate light throughout the campsite and must be constantly moved leaving some areas in the dark. Additionally, traditional light sources that run on fossil fuel or disposable batteries are limited in the length of operation and require the outdoor enthusiast to bring additional fuel or batteries.

Thus, there exists a need for a camping lighting system that provides a user's desired light output and coverage while having a rechargeable power source that can be wirelessly controlled to manage light output and power usage.

### SUMMARY OF THE INVENTION

The invention is a lighting system for camping having a light-emitting diode (LED) lamp with a LED light source powered by a rechargeable battery unit. The LED lamp is generally surrounded by a light shade that can be used to direct the light produced from the LED lamp and cast light-effects via a patterned attachment. The LED lamp and light shade are suspended from an aerial mast. A base supports the aerial mast on a support surface. The aerial mast is configured to support the LED lamp and light shade above the camp area. The LED lamp may be manually controlled via a switch or remotely controlled via a wireless system that communicates with the LED lamp. The LED lamp may be controlled wirelessly using a smart phone or other similar device and application software that control the functions of the LED lamp. The wireless device may communicate with the LED lamp using Bluetooth or another suitable communication protocol.

The LED lamp includes a LED light source and a rechargeable battery unit. The LED light source emits the light for the system. The LED light source may be in the shape of a puck with multiple, discreet LED bulbs located around the outer circumference of the puck. The LED light source may be in the shape of a wand with LED bulbs extending along the length of the wand. In another alternative, LED bulbs may be integrated into a cord to provide a flexible LED light source. Although the above configurations are common, LED bulbs of the LED light source may be configured in additional ways within the scope of the invention.

The rechargeable battery unit is used to power the LED light source. In an embodiment of the invention, the LED light source connects to the rechargeable battery unit via a universal serial bus (USB) port, with magnetic charging or other similar charging method. In another embodiment, a magnetic connection provides the link between the LED light source and the rechargeable battery unit. The rechargeable battery unit may be recharged by using a wall outlet, a 12V power source, 5V power source, or another power source such as solar power.

In addition to providing power to the LED light source, the rechargeable battery unit may include the control system for the LED lamp. The LED lamp may be turned on and off using a manual switch. The rechargeable battery unit may include a communication system for wireless communication with a remote handheld device such as a smartphone. A Bluetooth radio and software system or another suitable communication system may be used to communication between the rechargeable battery and the remote device. The remote device can be used to control various features of the LED lamp such as on/off control or dimming. The LED lamp control system may also be located in the LED light source.

Although the LED lamp may be used on its own, typically, the LED lamp will include the light shade. The light shade provides light transmission control to cast light over a broad or narrow area as desired by the user. The light shade may also be used to cast various light effects. In one embodiment, the light shade is collapsible or foldable for easy transport and storage. The light shade may be configured as one piece or multiple pieces that overlay each other. The light shade is attached to the LED lamp by any suitable means.

The aerial mast is used to suspend the LED lamp and light shade above the camp area to be illuminated. The aerial mast has a distal end for suspending the LED lamp and a lower end including a base. The distal end is configured to retain the LED lamp and shade to the aerial mast. The base is constructed to be sufficient to support the entire camp lighting system. The aerial mast is typically collapsible for transport and storage. The aerial mast may be constructed of multiple members that connect together to form the length of the mast. The individual members may be straight or curved to provide the desired offset between the base and the LED lamp and lampshade. Individual members may be constructed have a circular shape, oval shape, elliptical type shape, or some other non-circular shape. A non-circular shape may be desired in certain circumstances such as windy weather because a non-circular shape may add strength to resist twisting of the aerial mast between individual members of the mast and between the mast members and the base of the mast.

As stated above the lighting system may be controlled manually or by a remote device. The manual control would be accomplished by use of a switch with on/off and dimmer controls. Remote control of the system is accomplished using the remote control device. The remote control device may consist of a smartphone or similar device. The smartphone includes a mobile application to control various features of the LED lamp such as turning on and off the lamp, changing the lamp's brightness, changing the lamp's color, indicating remaining battery life, and varying the LED lamp effects to music. As stated above, communication between the remote control device and the LED lamp may be by Bluetooth or other suitable communication system.

It is within the scope of the present invention that the lighting system may be adapted to illuminate an entire campsite, an individual cooking area, tent space, or other area. The present invention may also be adapted for use with RV camping or backyard camping. The level of illumination, the construction of the light shade, the size of the system, and length of the aerial mast may be adapted for various uses.

Although the embodiments of the present invention are not limited by the following drawings, many aspects of the present invention can be better understood with reference to the following drawings. The components in the drawings are not necessarily drawn to scale, the emphasis instead being placed upon clearly illustrating the principles of the present invention. Moreover, in the drawings, like reference numerals designate corresponding parts throughout the several views.

### BRIEF DESCRIPTION OF THE DRAWINGS

FIG. 1 is a view of the LED lighting system including a remote control device;

FIG. 2 shows a LED light source in the shape of a puck;

FIG. 3 shows a LED light source in the shape of a wand;

FIG. 4 shows a LED light source in the shape of a string;

FIG. 5 shows a rechargeable battery unit to provide power to the LED light source;

FIG. 6 shows an embodiment of a light shade of the current invention;

FIG. 7 demonstrates an light shade attachment that may be used to cast decorative shadows;

FIG. 8 shows an embodiment of the aerial mast;

FIG. 9 is a view of an triangular cross-section of a segment of the aerial mast;

FIG. 10 is a view of an elliptical cross-section of a segment of the aerial mast;

FIG. 11 is a view of an embodiment of a remote control device comprised of a smartphone including a control app.

FIG. 12 shows an embodiment of a feature of the lighting control application demonstrating remaining power.

### DETAILED DESCRIPTION OF INVENTION

The following detailed description is of exemplary embodiments of the invention. The description is not to be taken in a limiting sense but is made merely for the purpose of illustrating the general principles of the invention, since the scope of the invention is defined by the claims. Various inventive features are described below that can be used independently of one another or in combination with other features.

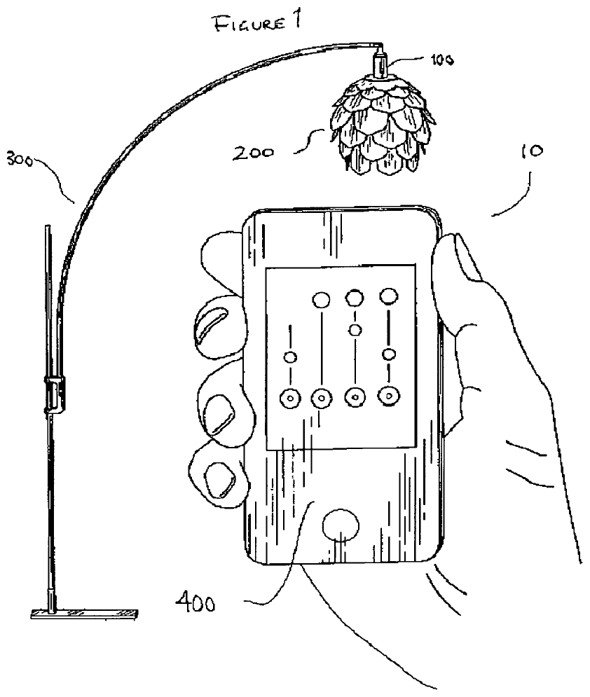

Broadly, with reference to FIG. 1, embodiments of the present invention generally provide a lighting system 10 for use to light a campsite. The lighting system comprises a LED lamp 100, a light shade 200 covering the LED lamp, an aerial mast 300 configured to suspend the LED lamp over the desired area, and a remote lighting control system 400 to manage various features of the LED lamp 100 and lighting system 10. The lighting system may be stored and transported in wheeled transporter 500. The lighting system may include all or portions of the components listed above.

The LED lamp 100 generally contains a LED light source 110 and a rechargeable battery unit 160. The LED light source 110 is comprised of at least a single LED bulb 120 and the associated LED circuitry. One of skill in the art would know that many different options are available for the selection of a suitable LED bulb 120. In one embodiment, the LED bulb 120 is selected from Cree®. The selected LED bulb 120 may contain the required electronics or the LED light source may contain the required electronics or both. The LED light source 110 is not limited to a specific LED configuration.

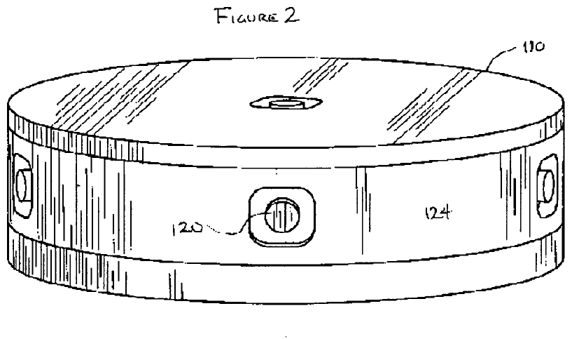

FIG. 2 shows an embodiment of the LED light source 110. The LED light source 110 may be configured in several different ways. In one embodiment, the LED light source 110 is configured in the shape of a LED puck 124. Four LED bulbs are spaced 90 degrees from each other to provide 360-degree illumination coverage. The LED Puck 124 maybe configured to provide illumination in the upward, outward or downward direction. The LED puck 124 may include one or more LED bulbs 120 as desired. The LED bulbs 120 may be recessed into the puck 124 to provide protection from breakage. The LED bulbs 120 may be external to the puck 124 to provide greater illumination.

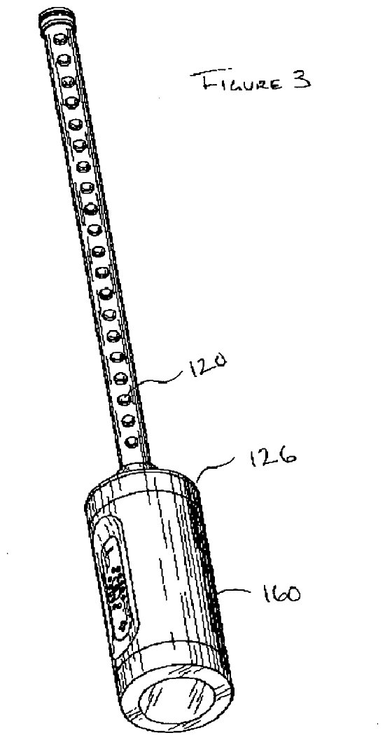

In another embodiment, FIG. 3 shows the LED light source 110 configured in the shape of a LED wand 126. The LED wand 126 may contain any desired number of LED bulbs 120 to provide the length and illumination required for a desired application. The LED wand has the same functionality and componentry as the LED puck 124. In one embodiment, the LED wand 126 is interchangeable with the LED puck 124.

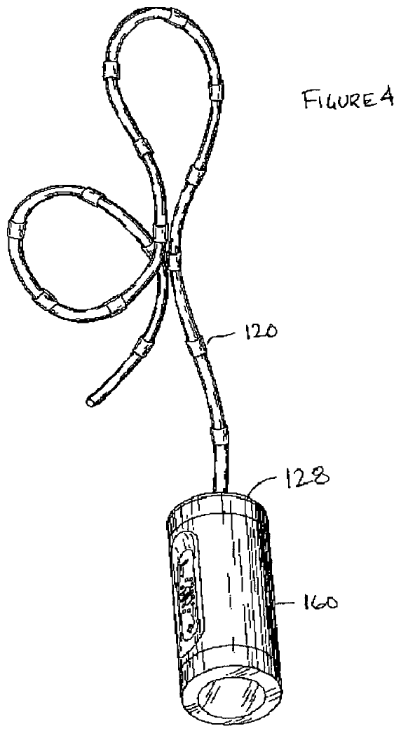

In still another embodiment, FIG. 4 shows the LED light source 110 in the configuration of a LED string 128. The LED string 128 may contain any desired number of LED bulbs 120 to provide the length and illumination required for a certain application. The LED string 128 has the same functionality and componentry as the LED puck 124. In one embodiment, the LED string 128 is interchangeable with the LED puck 124 or the LED wand 126.

The LED string 128 may be configured as a typical LED light string, or it may be reinforced with a structural nylon or other such reinforcement. In one embodiment, the LED string 128 is reinforced with nylon such that the nylon reinforcement can bear a load along the length of the LED string 128 without placing any load on the LED bulbs 120 themselves or the LED string wiring or circuitry. The LED bulbs 120 and LED wiring are woven or threaded internally into the nylon cordage of the LED string 128 that supplies the necessary strength to bear a load while removing any loading from the LED bulbs or wiring. When loaded, the nylon cordage supports the load or weight relieving stress from the LED string 128. In one embodiment the LED string 128 can be used to hold other camping implements such as additional lighting or cooking gear while providing illumination to use the gear when it is in the dark. In another embodiment, the LED string 128 may be used in conjunction with the LED puck 124 or the LED wand 126 in a manner similar to an extension cord while providing additional light. This and other embodiments are within the scope of the present invention.

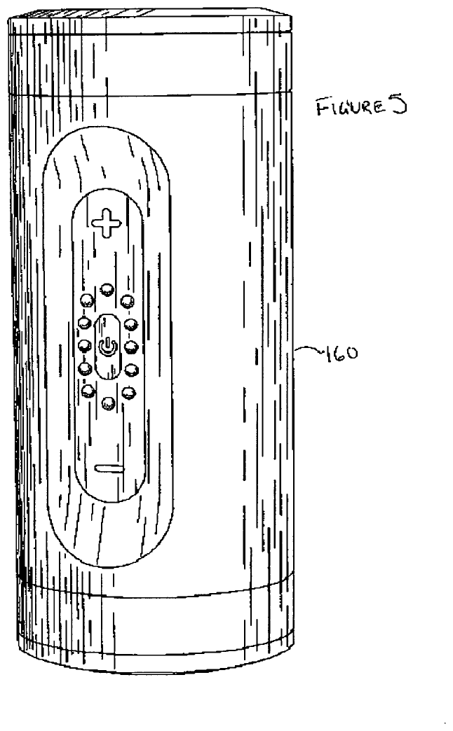

FIG. 5 shows an embodiment of the rechargeable battery unit 160. The LED light source 110 communicates with the rechargeable battery unit 160 to provide power to illuminate the LED bulb(s) 120. In one embodiment, the LED light source 110 has a USB port to communicate with the rechargeable battery 160. The LED light source 110 has a male USB connector that plugs into a female USB port on the rechargeable battery unit 160. The LED light source 110 may have the female port and the rechargeable battery 160 may contain the male connector.

The LED light source 110 may communicate with the rechargeable battery unit 160 by any removable connection sufficient to transfer power and any required information between the LED light source 110 and the rechargeable battery unit 160. The LED light source 110 may connect to the rechargeable battery unit 160 via a magnetic connection that allows for transfer of power and other information from the rechargeable battery unit 160 to the LED light source 110.

FIG. 1 shows the LED lamp 100 and the remote lighting control system 400. The LED light source 110 may contain a communication system for communicating with the remote lighting control system 400 to control the lighting provided by the LED light source 110 and provide feedback on the lighting system 10 such as remaining battery level or remaining time LED light source 100 can be powered. In another embodiment, the communication system is located in the rechargeable battery unit 160 and communicates information and feedback to the LED light source 110 via the USB connection or other suitable connection.

The rechargeable battery unit 160 powers the LED lamp 20. There are many types of rechargeable batteries on the market today, including, but not limited to, nickel/cadmium, nickel/metal hydride, lithium ion, or lithium ion polymer. Any of these variations can be used with the present invention. One embodiment of the present invention connects multiple batteries to each other via a suitable connector to provide longer battery life. The present invention also includes a recharger. The recharger may be a standard recharger that plugs into a typical wall outlet to recharge the rechargeable battery unit 160. An alternate recharger allows for operation from a 12V automobile accessory outlet or other 12V source. In another embodiment, the rechargeable battery unit 160 may be recharged via a 5V power source or a source of any voltage. In still another embodiment, the rechargeable battery unit 160 may be recharged via an alternative energy source. The rechargeable battery unit 160 may be recharged by solar energy, wind energy, water energy, etc.

Connectivity between the rechargeable battery unit 160 and the recharging source maybe by a typical wired connection, it maybe wireless communication, or it may be through magnetic connection. In one embodiment, magnets connect the rechargeable battery unit 160 to the recharger and transfer energy through the connection to provide a recharge. The rechargeable battery unit 160 may connect to the recharger through the same connection as the rechargeable battery unit 160 connects to the LED light source 110.

The cordless nature of a rechargeable battery unit 160 makes it suitable for any outdoor activity, as the user is not limited to the length of an electrical cord. Likewise, the LED lamp 100 may be made with waterproof connections to facilitate use in the outdoors. An alternative power source can be used to power the LED lamp 100. The rechargeable battery 160 may be configured to accept a power cord attached to a typical wall outlet or to a 12V battery source. In another embodiment, a power cord adapter may be used in place of the rechargeable battery 160 to permit powering the LED lamp 100 by an external power source. An alternative LED light source 110 may also be configured to accept a cord to provide power source instead of a rechargeable battery. Additionally, the traditional batteries may power the LED light source 110 in an adapter suitably designed to allow traditional batteries to power the LED light source 110.

In an alternative embodiment, the LED lamp 100 may include multiple components and may include a link member to join the LED light source 110 to the rechargeable battery unit 160. The link member may include control functions such as a switch or dimmer and it may provide a battery life indicator. The link member may also include the communication system for remotely controlling the LED lamp 100 via the lighting control system 400. The link member, the LED light source 110 and the rechargeable battery unit 160 may connect to each other using a suitable connection discussed above including a USB connection or a magnetic connection.

As discussed above, the LED light source 110 may be attached or attach to the rechargeable battery unit 160 via a magnetic connection. In this embodiment, the LED light source 110 would have the communication system to communicate with the lighting control system. The rechargeable battery 160 would conduct energy to the LED light source 110 via the magnetic connection. In an alternative, the link member may connect to the rechargeable battery via magnetic connection. In such an embodiment, the link member would have the communication system to communicate with the lighting control system. The LED light source 110 may connect directly to the rechargeable battery unit 160 in such an arrangement with limited functionality, as the magnetic connection would provide power to the light but may not provide communication for all features.

The LED lamp 100 may include manual controls such as an on/off switch, a dimmer switch, and/or a switch to change lighting modes or lighting colors. Alternatively, timer controller is provided. These control features may be included in the LED light source 110, the rechargeable battery unit 160, or the link member.

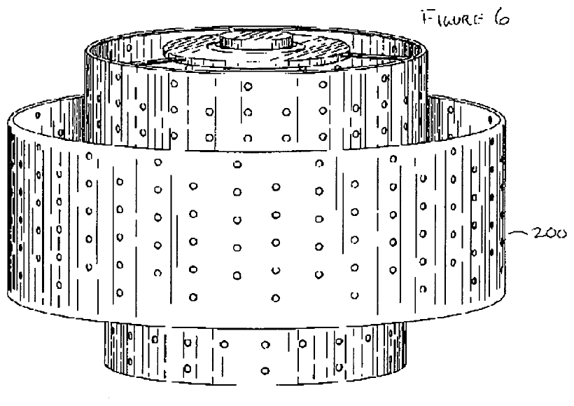

FIG. 6 shows an embodiment of the light shade 200. The light shade 200 is configured to distribute light from the LED lamp 100 down onto the campsite. The light shade 200 may be opaque to minimize the amount of light that is viewed in other campsites. In a different embodiment the light shade 200 may be translucent to distribute light more generally.

The light shade 200 is generally collapsible or foldable for transportation and storage ease. The light shade 200 may be configured from several leaves that may fold over or onto each other either radially or in a stacking form such that the light shade 200 may lay flat or relatively collapsed during storage. In another embodiment, portions of the light shade 200 are configured to hinge upon each other with the intention of sections of the lampshade folding to lay flat or relatively collapsed. In still another embodiment, the elements of the light shade nest to permit the light shade collapse. In yet another embodiment, the lampshade is formed and stored using origami folding techniques.

The light shade 200 is configured to fit over all or a portion of the LED lamp 20. The lampshade may rest upon the LED light source 110, the rechargeable battery unit 160, or some other component. The lampshade may attach to the LED lamp 100 by mating with a threaded surface. The light shade 200 may entirely cover the LED lamp 100 or the LED lamp 100 may partially extend beyond the light shade 200.

In an alternative embodiment, the light shade 200 is configured as a sleeve to enclose the LED lamp 100. The sleeve may be collapsible to provide easier storage and transportation. It may entirely encapsulate the LED lamp 100 to reduce the amount of light cast or be adjusted to permit more illumination.

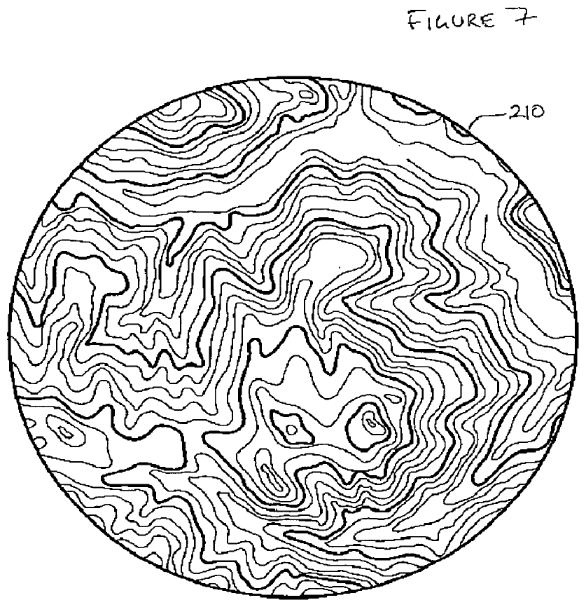

FIG. 7 shows an embodiment of a light-casting element 210. The light shade 200 may include a light-casting element 210 with the capability to cast objects on the campsite ground. The light-casting element 210 can cast several lighting effects such as art, patterns, words, characters, logos, etc. The patterns cast may be function or for fun. Examples of functional casts may indicate the name of the holder of campsite, stars and constellation's, limit the light at the campsite for mood, or cast a game such as hopscotch. Fun casts may be comic book characters or various patterns. The cast 210 may be built into the light shade 200 or it may attach over the opening of the light shade 200.

In an alternative to a light-casting element 210, the present invention may include a gobo to cast various shapes or elements. The gobo is a physical stencil or template that is placed in front of the LED light source 110, to control the shape or effect of the emitted light. The gobo may be created using traditional cutting means or laser cutting means to create more intricate shapes. The use of a gobo may be particularly desired in combination with the LED wand 126 or LED puck 124. For example, a gobo sleeve may be placed over the LED wand 126 to create a desire light cast effect.

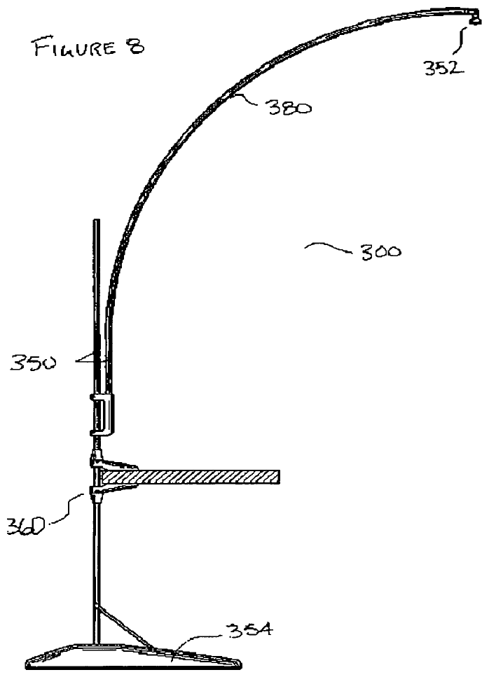

FIG. 8 shows an embodiment of the aerial mast 300. The LED lamp 100 is typically suspended above the campsite using the aerial mast 300. The aerial mast 300 is comprised of a pole 350 with a distal end 352 that attaches to the LED lamp 100 and a base 354. The attachment at the distal end 352 may be by way of a typical carabiner, magnet or by another attachment device sufficient to hold the weight and work in the environment. The lower end of the pole 350 fits into the base 354 that is sufficient to hold the aerial mast 300 and the other components of the LED light system 10. The base 354 may be attached to the ground using stakes. In an alternative, the base 354 is configured to be supported on a surface using a weight sufficient to support the aerial mast 300. This weight may be a water jug or some other weighted object. The base 354 and the pole 350 may be fixedly attached or may be separate components. In one embodiment, the pole 350 is a separate, collapsible piece that extends in the same manner as a typical tent pole. Individual segments are connected using an elastic cord. These individual segments fit end to end to form one pole. The length of the pole is dependent upon the number of segments that are used. Once the pole 350 is constructed, it is fit into the base to form the aerial mast 300. The individual segments may be either straight or have curved sections or a combination of both. The pole 350 may be made from one segment or multiple segments joined together. May be supported by a camp table, a picnic table or part of a car.

In another embodiment, FIG. 8 shows the pole 354 of the aerial mast 350 with a telescoping feature to provide greater adjustability of height. In still another embodiment, FIG. 8 shows the pole 350 of the aerial mast 300 containing a mid-support 360 that may be clamped to a table or similar object. The mid-support 360 of the pole 350 can provide additional support to the aerial mast 300 to provide heighten elevation of the LED lamp above the area to be illuminated.

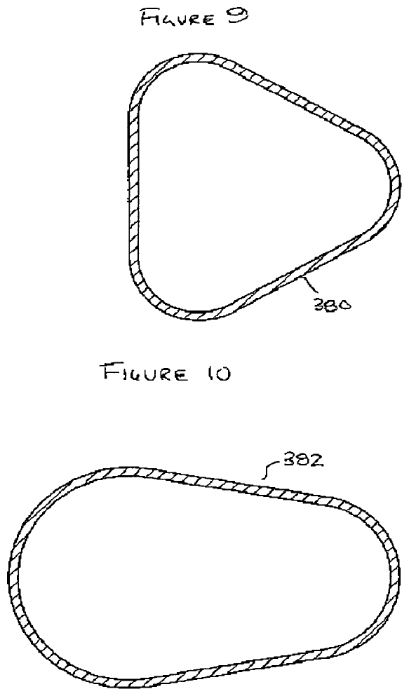

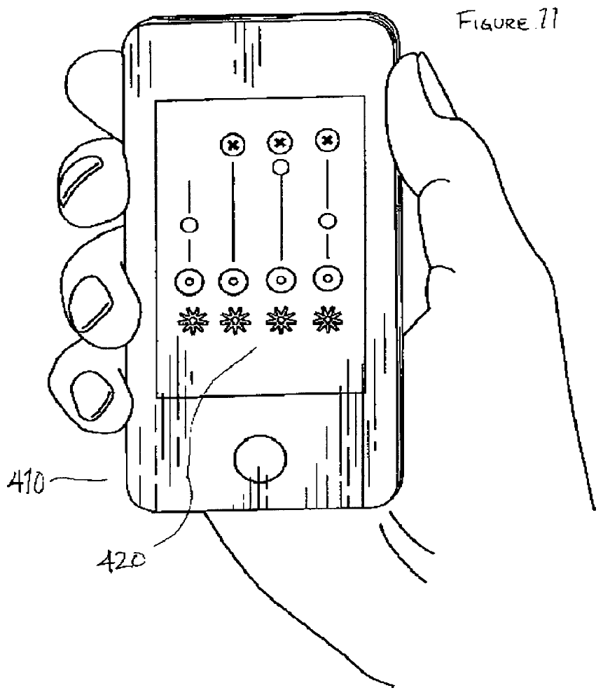

The pole 350 may be formed from segments with different cross-sectional shapes. It may be desirable to limit the movement of the aerial mask in windy conditions and add additional strength. FIG. 10 shows a pole 350 with segments having an elliptical cross-section 382 that may be used such that the segments will not twist relative to each other. When combined with a similar elliptical connection in the base 354, the LED lamp 100 can be suspended in one place with minimal movement. The segments of the pole 350 may be of another such shape that fit together to limit movement between the segments. FIG. 9 further shows a generally triangular cross-section pole segment 380. Pole segments with an egg-shaped cross-section can also be used. Again, such a segment with an egg-shaped cross-section will limit twisting and movement among the segments so that the pole will limit movement in inclement weather.

Another embodiment of the aerial mast 300 contains the on/off switch, dimmer switch, timer switch, and other manual controls discussed above. In this variant, the desire control is mounted to a segment of the pole 350.

Optionally, the pole 350 and the base 354 are configured to rest on a table. In this embodiment the pole length is shorter to match the desired use. Generally, the length of the aerial mast 300 may be adjusted to suit the desired application.

In another embodiment, an alternative power source in the form of an electrical cord may be wound around the aerial mast 300 or may run up through the aerial mast 300 pole 350. The system may accommodate both a battery system or a system powered by an electrical cord.

An additional embodiment shown in FIG. 13 of the aerial mast 300 has one or more pole segments 380 attached to the aerial mast 300. These one or more pole segments 380 may each support an LED lamp 100. FIG. 15 shows another embodiment of the invention where accessories are attached to the aerial mast 300. These accessories may include tables, solar panels, or additional LED lighting sources 110 such as a LED puck 124, LED wand 126, or LED string 128.

FIG. 1 shows the LED lighting system 10 remotely controlled by the remote lighting control system 400. In one embodiment, the remote lighting control system 400 is comprised of an IR functional device though those skilled in the art will recognize that other methods are certainly contemplated within the scope of the invention. In such embodiment, the remote lighting control system 400 provides IR signals to the communication system in the LED lamp 100 to perform certain functions, for example, turn on, turn off, dim, actuate a timer controller and the like. The communication system receives the signal and in turn carries out the desired functions of the LED lamp 100.

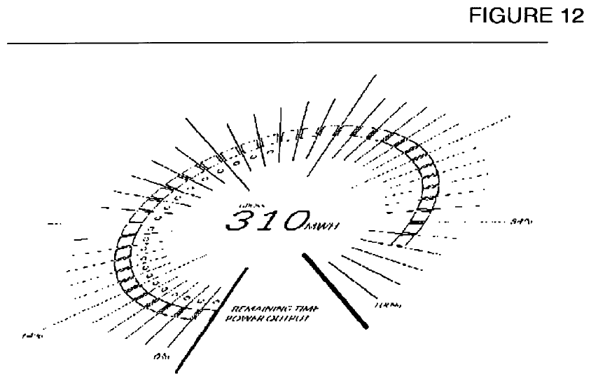

FIG. 11 shows another embodiment of the remote lighting control system 400 that includes a smartphone 410 with a lighting control application 420. The smartphone 410 may be a typical smart phone with touch screen capability and the ability to download an application for controlling the LED lamp 100. Typical functions of the software lighting control application 420 may include on/off switching, dimmer switching, battery life metering, a timer, battery consumption control, synchronization of casting with various music, flashing light modes, color light modes, etc. The smartphone application may indicate functionality using dials, bars, or other means of indicating appropriate level. FIG. 12 is an embodiment of a feature of the lighting control application 420 that shows the remaining power output of the rechargeable battery unit 160.

The lighting system 10 is generally transportable and each component is designed to provide use in a number of different campsites. FIG. 14 shows one embodiment where each of the components of the lighting system 10 is designed to be transported in a single container unit 500. The container unit 500 is configured to store and transport the lighting system 10, and as such, each lighting system component is designed to break down in size to fit in the single container unit 500. The container unit generally has wheels so that it may be moved from a vehicle to the location for set up with ease.

The single container unit 500 may all provide the recharging features discussed above. The single container unit 500 may have an integrated solar recharging station, a location for a 12V battery recharger, and/or necessary connections for recharging the rechargeable battery unit 160 from a car battery or wired outlet.

In an embodiment, the single container unit may form the base 354 of the aerial mast 300. The lower end of the pole 350 of the aerial mast 300 fits into the single container unit 500. The single container unit 500 provides weight and stability to the system to support the aerial mast 300.

Although the invention is related to use while camping, the invention may be used in a number of different locations including indoors or outdoors. The elements of the disclosed invention may be used together, together in part, or alone. For example, any of the embodiments of the light source may be used alone or in combination with the other elements of the invention. One understands that the foregoing relates to exemplary embodiments of the invention and that modifications may be made without departing from the spirit and scope of the invention as set forth in the following claims.

What is claimed is:

1. An outdoor lighting system comprising:
a LED lamp having a LED light source and a removable battery unit;
an aerial mast removably attached to the LED lamp for supporting the LED Lamp above a surface;
a base configured to support the aerial mast; and
wherein the LED Lamp contains a wireless control module for wireless control of the LED light source.

2. The outdoor lighting system of claim 1 wherein the LED light source is a LED puck.

3. The outdoor lighting system of claim 1 wherein the LED light source is a LED wand.

4. The outdoor lighting system of claim 1 wherein the LED light source is a LED string.

5. The outdoor lighting system of claim 1 wherein the LED light source is connected to the removable battery via a USB connection.

6. The outdoor lighting system of claim 1 wherein the base is a clamp configured to attach to the surface.

7. The outdoor lighting system of claim 1 wherein the LED light source is magnetically connected to the removable battery

8. The outdoor lighting system of claim 1 further comprising a container unit configured to store the components of the lighting system.

9. An outdoor lighting system comprising:
a LED lamp having a LED light source and a removable battery unit;
a light shade attached to the LED lamp;
an aerial mast removably attached to the LED lamp for supporting the LED Lamp above a surface;
a base configured to support the aerial mast; and
wherein the LED Lamp contains a wireless control module for wireless control of the LED light source.

10. The outdoor lighting system of claim 9 wherein the LED light source is a LED puck.

11. The outdoor lighting system of claim 9 wherein the LED light source is connected to the removable battery via a USB connection.

12. The outdoor lighting system of claim 9 wherein the LED light source is magnetically connected to the removable battery.

13. The outdoor lighting system of claim 9 wherein the light shade is configured to cast shapes on the surface.

14. The outdoor lighting system of claim 9 further comprising a container unit configured to store the components of the lighting system.

15. An outdoor lighting system comprising:
a LED lamp having a LED light source connected to a removable battery unit via a USB connection;
an aerial mast removably attached to the LED lamp for supporting the LED Lamp above a surface;
a base configured to support the aerial mast; and
wherein the LED Lamp contains a wireless control module and receiver for wireless control of the LED light source.

16. The outdoor lighting system of claim 15 wherein the LED light source is a LED puck.

17. The outdoor lighting system of claim 15 wherein the LED light source is a LED wand.

17. The outdoor lighting system of claim 15 wherein the LED light source is a LED string.
